(19) United States
(12) Patent Application Publication
(10) Pub. No.: US 2007/0081708 A1
(43) Pub. Date: Apr. 12, 2007

(54) Method for projecting radiological image data into a neuroanatomical coordinate system

(76) Inventor: Eckhard Hempel, Furth (DE)

Correspondence Address: HARNESS, DICKEY & PIERCE, P.L.C., P.O.BOX 8910, RESTON, VA, 20195, US

(21) Appl. No.: 11/525,967

(22) Filed: Sep. 25, 2006

(30) Foreign Application Priority Data
Sep. 26, 2005 (DE) 10 2005 045 908.0

(51) Int. Cl. G06K 9/00

(52) U.S. Cl. 382/128

(57) ABSTRACT

A method is described for projecting radiological image data of at least a part of a brain into a neuroanatomical coordinate system. To this end, anatomical reference marks in the initial radiological image data are determined in an automated fashion and a rotation and/or displacement of the initial radiological image data is carried out, with at least some of the anatomical reference marks in the rotated and/or displaced image data match corresponding anatomical reference marks in the neuroanatomical coordinate system. The rotated and/or displaced image data are then converted into the neuroanatomical coordinate system by a transformation. An image data processing device for projecting initial radiological image data according to the method and a radiological system having a corresponding image data processing device are also described.

### PRIORITY STATEMENT

The present application hereby claims priority under 35 U.S.C. §119 on German patent application number DE 10 2005 045 908.0 filed Sep. 26, 2005, the entire contents of which is hereby incorporated herein by reference.

### FIELD

The invention generally relates to a method for projecting initial radiological image data of at least a part of a brain into a neuroanatomical coordinate system. The invention also generally relates to a corresponding image data processing device which converts initial radiological image data into a neuroanatomical coordinate system according to such a method, as well as to a radiological system having such an image data processing device.

### Background

Imaging systems in medical technology (often also referred to as “modalities”) such as X-ray systems, computer tomographs or magnetic resonance tomographs are nowadays regularly used for studying the brain. The radiological image data generated by the imaging systems are used, for example, to make disease diagnoses, to evaluate disease progressions or to plan operative interventions. The imaging systems are also employed for clinical studies on a multiplicity of patients or subjects, in which case common features of brain anatomy or function as well as individual divergences are studied.

It is clear that the individual anatomical properties of the brain, for example differences in the respective geometrical extent and shape of a brain, hinder efficient evaluation of the radiological image data. This also applies particularly to the anatomical localization of brain activities which have been recorded with the aid of a functional magnetic resonance scan.

Patent Specification U.S. Pat. No. 6,240,308 B1 describes a method in which digitized maps from “brain atlases”, which are known in the specialist field, are manipulated in such a way that they can be superimposed on an individual recording of a patient's brain, for example so that the medical terms used in the maps lie on the corresponding positions of the individual patient image data, which simplifies the analysis of the image data for the user. Yet since the patient image data remain substantially unchanged in this method, the individual properties of a brain make it more difficult to statistically evaluate the radiological image data of a plurality of persons, for example in order to generate anatomical or functional average-value images. In medical practice, it is therefore often necessary to project the individual radiological image data of the brain into a standardized neuroanatomical coordinate system.

An example which may be mentioned for such a neuroanatomical coordinate system is the coordinate system according to Talairach, which is widely used particularly for the localization of brain activities. FIG. 3 shows an example of radiological image data of a brain, which have been projected into the Talairach coordinate system. Such a projection requires inter alia that characteristic anatomical structures be identified within the individual radiological image data, for example so-called “anatomical landmarks” whose geometrical position is often described in the brain atlases. The geometrical position of the anatomical structures dictates the way in which the radiological image data should be processed in order to project them into a standardized neuroanatomical coordinate system.

Patent Specification U.S. Pat. No. 5,827,499 already discloses standardization of image data in positron emission tomography (PET), which takes place with the assistance of anatomical landmarks. However, identification of the anatomical landmarks and projection of the radiological image data by the user of the image data require a great time outlay. Such a process is furthermore susceptible to error since, for example, correct identification of the anatomical landmarks depends on the respective experience of the user. It is therefore also clear that the comparison of image data which have been projected by different users onto a neuroanatomical coordinate system is only limitedly possible owing to the individual influence of the user during the projection.

### SUMMARY

In at least one embodiment of the present invention, a method is provided for projecting initial radiological image data of at least a part of a brain into a neuroanatomical coordinate system, which can be carried out in a substantially automated fashion so that the image data are available for the user promptly and in a uniform form.

In the method according to at least one embodiment of the invention, anatomical reference marks in the initial radiological image data are first determined in an automated fashion. Anatomical reference marks of the brain may inter alia be points, lines or planes. For example, the anterior spatial boundary of the brain represents a point-like anatomical reference mark while the interhemispheric fissure (IHF) between the two brain halves is an anatomical reference mark in planar form. Linear anatomical reference marks may be connecting lines between two characteristic anatomical landmarks of the brain.

An example which may be mentioned here is the connecting line between the anterior commissure (AC) and the posterior commissure (PC). Besides automated analysis of the radiological image data, the automated determination of the anatomical reference marks may thus also involve an automated calculation of lines or planes.

In a further step the initial radiological image data are subjected to a rotation and/or displacement, with the aim that at least some of the anatomical reference marks in the rotated and/or displaced image data match corresponding anatomical reference marks in the neuroanatomical coordinate system. The effect achieved by this is to normalize displacements or rotations which result from the image data recording, for example a rotation of the head, or from individual anatomical properties of the brain. For a projection into the Talairach coordinate system, for example, the initial radiological image data are rotated and/or displaced until the connecting line between the AC and PC extends horizontally and the IHF plane passes through the coordinate origin. Optionally, instead of complete overlap with the anatomical reference marks of the neuroanatomical coordinate system, only an approximation of complete overlap is achieved during the rotation and/or displacement.

The steps according to at least one embodiment of the invention for the automated determination of the anatomical reference marks and the rotation and/or displacement of the initial radiological image data may in principle also be executed a multiplicity of times iteratively, that is to say after a rotation and/or displacement has been completed this is followed by a further automated determination of anatomical reference marks, which is in turn the starting point for a further rotation and/or displacement.

In a further step the rotated and/or displaced image data are transformed into the neuroanatomical coordinate system, that is to say the coordinates of the neuroanatomical coordinate system are assigned to the image data with the aid of a transformation method. Such transformation methods may inter alia be given by a plurality of linear or nonlinear equations, with which the coordinates of the neuroanatomical coordinate system are calculated. Transformation methods in which three-dimensional image data are divided into a plurality of volume elements, and each of these volume elements is described by a combination of coordinate values of the neuroanatomical coordinate system, are furthermore conceivable.

With the aid of the method according to at least one embodiment of the invention, radiological image data of the brain can be preprocessed in a substantially automated fashion and therefore relatively quickly so that they can be compared easily with image data of other brains, even when the initial radiological image data differ owing to the respective individual anatomical properties of the brain and a special situation possibly existing during the image data recording. In particular, the “standardization” of the determination of the anatomical reference marks makes it possible to generate anatomical or functional average-value images for a multiplicity of patients or subjects efficiently by the method according to the invention, which facilitates especially the conduct of clinical studies. Divergences, which could result if the anatomical reference marks are identified with the involvement of a user, are precluded.

An image data processing device according to at least one embodiment of the invention, which projects initial radiological image data of at least a part of a brain into a neuroanatomical coordinate system, must contain an identification device for the automated determination of anatomical reference marks in the initial radiological image data. The image data processing device furthermore requires a normalizing device which carries out a rotation and/or displacement of the initial radiological image data, with the aim that at least some of the anatomical reference marks in the rotated and/or displaced image data match corresponding anatomical reference marks in the neuroanatomical coordinate system. Lastly, the image data processing device must comprise a transformation device which determines transformed image data in the neuroanatomical coordinate system from the rotated and/or displaced image data.

Further particularly advantageous configurations and refinements of embodiments of the invention are given by the following description.

An analysis of the brightness values in the initial radiological image data is preferably carried out for automated determination of the anatomical reference marks. The brightness values in the image data conventionally represent the degree of attenuation of the imaging signal when it passes through the brain. In practice, the degree of attenuation is often specified in so-called Hounsfield units (HU) relative to the attenuation when passing through water. For example, a strong local HU variation may therefore indicate a transition from tissue material to bone material. Particularly when determining individual anatomical reference marks which describe the maximum geometrical extent of a brain, an analysis of the image data in HU may be sufficient.

The analysis of the brightness values may preferably be restricted to a subset of the initial radiological image data. This restriction of the “search space” for an anatomical reference mark simplifies its identification in the image data. For example, it is expedient to restrict the search space for the upper brain boundary correspondingly to the upper image data region. For determining the AC, on the other hand, a restriction to a region of the image data inside the brain is recommendable.

In addition to the analysis of the brightness values, the automated determination of the anatomical reference marks may be assisted if anatomical structures, for which a respective characteristic position in the brain and whose position relative to an anatomical reference mark are known, are identified in the initial radiological image data. For example the liquor spaces of the brain, which are familiar to experts in the specialist field, are suitable as landmarks for determining the anatomical reference marks. The identification of anatomical structures and the anatomical reference marks may also resort to methods of artificial intelligence, for example the methods of neural networks or fuzzy logic.

In an example embodiment of the method according to the invention, the transformation of the rotated and/or displaced image data also involves scaling. Such scaling may inter alia be used to modify the radiological image data of different persons so that the extents of the brains, i.e. for example the distance between the anterior and posterior brain boundaries, are projected onto uniform values. This improves the comparability of the radiological image data.

The method according to at least one embodiment of the invention is not restricted to a particular neuroanatomical coordinate system. The neuroanatomical coordinate system which is used may depend on the specific study task or the specialist medical field, for example neuropathology, neuroanatomy or neurology.

In an example embodiment of the method according to at least one embodiment of the invention, the method steps are configured so that the initial radiological image data are converted into the Talairach coordinate system. In this case the anterior, posterior, left, right, upper (cranial) and lower (caudal) brain boundaries, as well as the IHF and the connecting line between the AC and PC, are determined in an automated fashion as anatomical reference marks.

By applying rotation and/or displacement steps, the connecting line between the AC and PC is moved into a horizontal position and the IHF plane is moved to the coordinate origin. Subsequently, the Talairach coordinates are calculated regionally. To this end, for example, the right and left brain halves between the IHF and the right or left brain boundary are respectively subdivided in the coronal direction (viewing direction “from the front”) into four sections which receive the coordinate values a, b, c and d.

In further steps of the coordinate transformation, the coordinate values (A to I, 1 to 12) are determined in a similar way for the other coordinate directions so that, at the end of the transformation, the Talairach coordinates (for example F3b) are available for all regions of the image data. These transformation steps are known to the experts in the specialist field, and will not therefore be discussed further here.

After the initial radiological image data have been projected into a neuroanatomical coordinate system with the aid of the method according to at least one embodiment of the invention, they may be provided for representation on a suitable image output device. Such a representation is preferably supplemented by giving the observer of the image data the opportunity to display the coordinates of the neuroanatomical coordinate system. This may be done by representing the coordinates in the image data for a selected image data region on the image output device following an action by the observer, for example actuating a key on an input instrument.

In a further example embodiment of the representation of radiological image data, which have been projected into a neuroanatomical coordinate system, the transformed image data of different brains are represented simultaneously. This makes it relatively easy for the observer to study common features and differences between the image data.

The steps of the method according to at least one embodiment of the invention are suitable for automated implementation. A preferred version of the method according to the invention is therefore a solution in which all method steps after a selection of initial radiological image data and actuation of a start device are performed fully automatically.

In order to carry out the method according to at least one embodiment of the invention, a radiological system contains a corresponding image data processing device and a user interface for representing the transformed image data on an image output device. The image data processing device may be part of an analysis station of the radiological system. Conventionally, such analysis stations are spatially separated from the recording instrument (also referred to as a scanner). In the normal case, the image data are processed after the recording of the image data has been finished, that is to say the analysis station operates in the so-called “offline” mode.

Such an implementation of the method according to at least one embodiment of the invention is recommendable particularly when a multiplicity of image data are to be projected into a neuroanatomical coordinate system, for example in the scope of clinical studies. The image data processing device may alternatively be a component of a control device (also referred to as a scanner console) of a modality, that is to say it is in spatial proximity to the recording instrument. This makes it possible for the image data to be projected into a neuroanatomical coordinate system while the patient or subject is still inside the recording instrument. In particular, this offers the advantage that the transformed image data are made available rapidly and sometimes even allow immediate decisions to be made about the further procedure of the image data recording.

The method according to at least one embodiment of the invention may be fully or partially implemented by software components which are run in the radiological system, that is to say in particular the identification device, the normalizing device or the transformation device may be embodied as software components. Conventional radiological systems have corresponding programmable devices for image data processing, so that at least one embodiment of the invention can be carried out by correspondingly adapting and supplementing the existing image data processing programs. That is to say a computer program product, which has program code segments for carrying out all the steps of the method according to at least one embodiment of the invention, is loaded directly into a memory of a programmable image data processing device of a radiological system.

### BRIEF DESCRIPTION OF THE DRAWINGS

The invention will be once more explained in further detail below with reference to the appended figures with the aid of example embodiments.

FIG. 1 shows a schematic representation of a radiological system according to an embodiment of the invention,

FIG. 2 shows a flow chart of an example alternative embodiment of the method according to the invention, and

FIG. 3 shows an example of the representation of a brain in the Talairach coordinate system.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

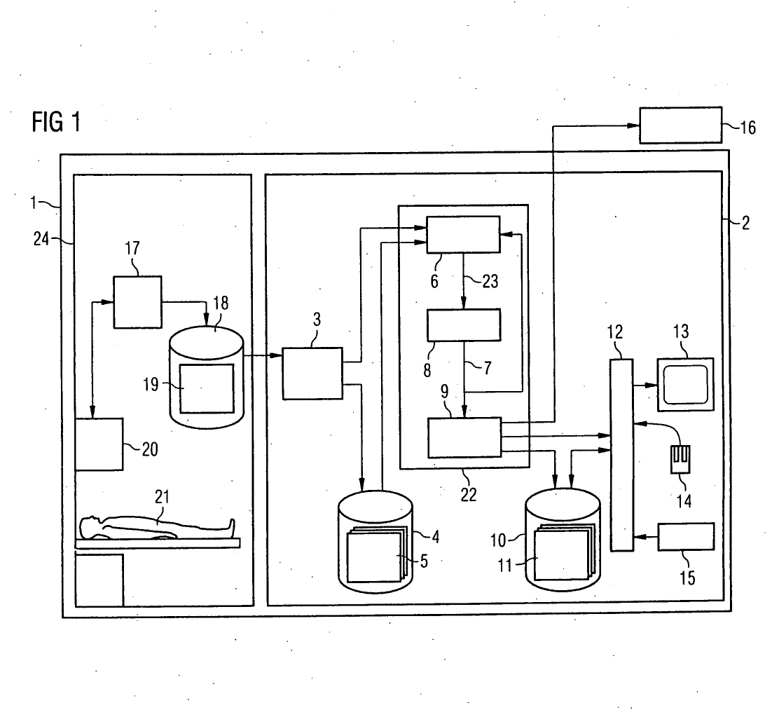

FIG. 1 shows an example embodiment of a radiological system 1, which is capable of operating with the method according to the invention. The radiological system 1 includes an analysis station 2 and a modality 24, which is capable of generating raw image data 19 of the brain of a patient or subject 21. Examples of a modality 24 are computer tomographs or magnetic resonance tomographs.

A recording instrument 20, which is controlled by a control device 17, generates the raw image data 19 which are conventionally stored in a raw image data memory 18 inside the modality 24. Other systems, such as the analysis station 2, can access the memory 18 and call up the raw image data 19. A modality 24 may have further components and features, for example processing devices for image data, image reconstruction devices, image output devices, keyboards or pointer instruments, although these are not represented in FIG. 1 for the sake of clarity.

The further processing of the raw image data 19 often takes place in an analysis station 2, which need not necessarily be in spatial proximity to the modality 24. The analysis station 2 is conventionally controlled via a user interface 12 to which for example input instruments such as a pointer instrument 14, e.g. a mouse, or a keyboard 15 are connected. The observation and analysis of image data takes place on one or more image output devices 13. An analysis station 2 may furthermore contain an image data preprocessing device 3 as well as databases 4, 10 for storing initial radiological image data 5 or transformed image data 11. For example, an image data preprocessing device 3 could take the raw image data 19 from the raw image data memory 18 of the modality 24 and carry out processing steps, such as adaptation of the contrast ratios or so-called windowing of the brightness values, and subsequently store the resulting initial radiological image data 5 in the database 4 where they are then available for further image data processing operations.

In order to carry out the method according to an embodiment of the invention, the analysis station 2 includes an image data processing device 22 which projects initial radiological image data 5 of at least a part of the brain into a neuroanatomical coordinate system. To this end, the image data processing device 22 contains an identification device 6 for the automated determination of anatomical reference marks 23 in the initial radiological image data 5. On the basis of the anatomical reference marks 23 which are determined, a normalizing device 8 carries out a rotation and/or displacement of the initial radiological image data 5 with the aim that at least some of the anatomical reference marks 23 in the rotated and/or displaced image data 7 match corresponding anatomical reference marks in the neuroanatomical coordinate system.

The image data processing device 22 according to an embodiment of the invention furthermore has a transformation device 9 which determines transformed image data 11 in the neuroanatomical coordinate system from the rotated and/or displaced image data 7. The transformed image data 11 may subsequently be represented, for example directly via the user interface on an image output device 13.

When observing the transformed image data 11, the user of the analysis station 2 may optionally modify the representation or query further information with the aid of input devices, for example a pointer instrument 14 or a keyboard 15. In particular, these include modifications such as rotating the representation or enlarging a detail. The coordinates of the neuroanatomical coordinate system, which are output for an image region selected with a pointer instrument 14, are an example which may be mentioned for the information that can be queried. The analysis station 2 may also have a database 10, in which the transformed image data 11 are stored. The analysis station 2 may furthermore output the transformed image data 11 to other devices, such as the image processing system 16 represented in FIG. 1. Examples of such image processing systems 16 are systems for imaging perfusion, diffusion or functions.

It should be pointed out that the radiological system represented in FIG. 1 is merely one embodiment of the invention. In a further embodiment, for example, the modality 24 could contain an image data processing device 22 as well as a user interface, image output devices and input instruments, so that radiological image data can be projected onto a neuroanatomical coordinate system and correspondingly provided for representation in the modality 24. The databases 4 and 10 shown in FIG. 1 could moreover be arranged spatially separated from the analysis station 2. An analysis station 2 according to the invention could furthermore access the raw image data 19 of a plurality of modalities 24, in order to project them into a neuroanatomical coordinate system.

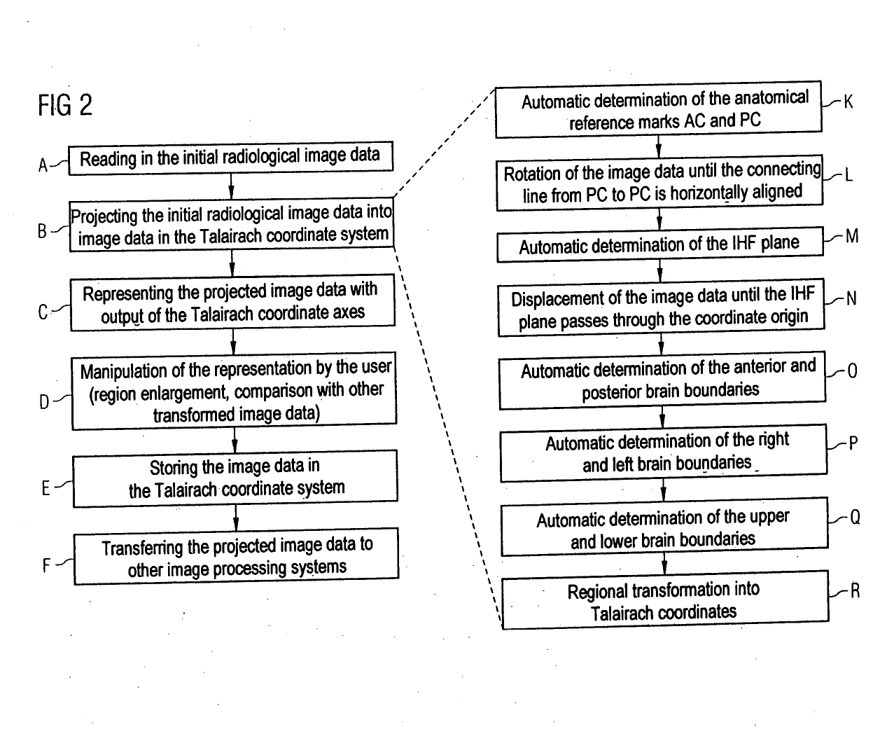

FIG. 2 shows a flow chart of an example alternative embodiment of the method according to the invention, in which initial radiological image data 5 are projected into the Talairach coordinate system. The individual steps of the method according to an embodiment of the invention are carried out by the steps K to R combined as step B—which represents the complete projection of the initial radiological images into image data in the Talairach coordinate system. The (sub)steps K, M, O, P and Q constitute the method step for automated determination of the upper and anatomical reference marks 23, which is carried out by an identification device 6. The reference marks AC and PC are determined automatically in step K, and the IHF plane in step M.

Step O represents the automatic determination of the anterior and posterior brain boundaries, step P the automatic determination of the right and left brain boundaries and step Q of the automatic determination of the upper and lower brain boundaries. The step L shown in FIG. 2, in which the image data are rotated until the connecting line from AC to PC is aligned horizontally, and N in which the image data are displaced until the IHF plane passes through the coordinate origin, correspond to the method step of rotation and/or displacement which is carried out by a normalizing device 8. Furthermore, step R represents the method step for transforming the rotated and/or displaced image data 7 into a neuroanatomical coordinate system, which is carried out by a transformation device 9.

After reading in the initial radiological image data 5 in step A, FIG. 2 shows the steps C to F as an example of further processing the image data generated by the method according to an embodiment of the invention. Step C corresponds to representation of the projected image data with output of the Talairach coordinate axes. Step D represents manipulation of the representation by the user, for example a region enlargement or a comparison with other transformed image data, step E represents storage of the image data in the Talairach coordinate system and step F represents transfer of the image data to other image processing systems.

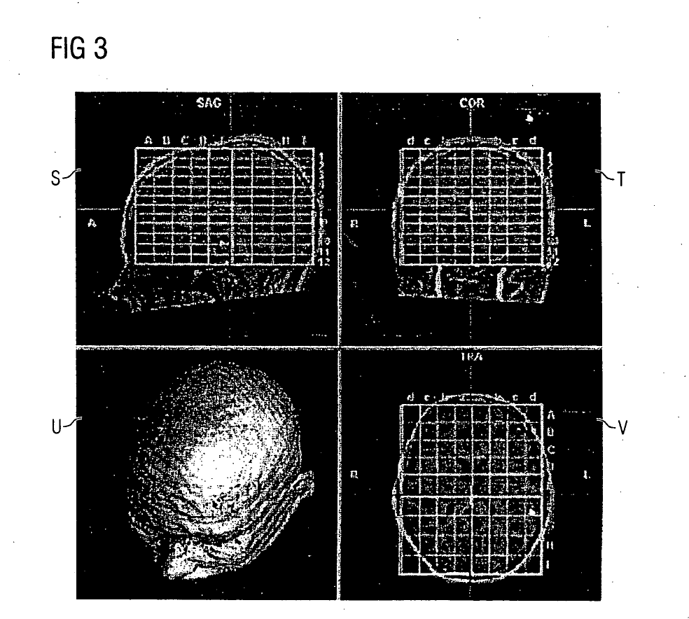

FIG. 3 shows an example of the representation of a brain in the Talairach coordinate system. Besides a three-dimensional view U (not further described here) of the patient or subject 21, views can be seen in the sagittal viewing direction S, in the coronal viewing direction T and in the transverse viewing direction V. The coordinates of the Talairach coordinate system are indicated for each of the three representations S, T and V, for example the Talairach coordinates A to I and 1 to 12 for the representation in the sagittal viewing direction S. Besides such two-dimensional representations of transformed image data 11, an analysis station 2 which carries out the method according to an embodiment of the invention may for example also represent the transformed image data 11 three-dimensionally.

To conclude, it should once more be pointed out that the radiological systems and method sequences described above are example embodiments, which experts in the specialist field may modify in a wide variety of ways without departing from the scope of the invention.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for projecting initial radiological image data of at least a part of a brain into a neuroanatomical coordinate system, the method comprising:
determining, in an automated fashion, anatomical reference marks in the initial radiological image data;
at least one of rotating and displacing the initial radiological image data, at least some of the anatomical reference marks in the at least one of rotated and displaced image data matching corresponding anatomical reference marks in the neuroanatomical coordinate system; and
transforming the at least one of rotated and displaced image data into the neuroanatomical coordinate system.

2. The method as claimed in claim 1, wherein an analysis of the brightness values in the initial radiological image data is carried out for automated determination of the anatomical reference marks.

3. The method as claimed in claim 2, wherein the analysis of the brightness values for automated determination of the anatomical reference marks is restricted to a subset of the initial radiological image data.

4. The method as claimed in claim 2, wherein anatomical structures, which are used as a further criterion for automated determination of the anatomical reference marks, are identified in the initial radiological image data.

5. The method as claimed in claim 1, wherein the transformation comprises scaling the at least one of rotated and displaced image data.

6. The method as claimed in claim 1, wherein the neuroanatomical coordinate system is a Talairach coordinate system.

7. The method as claimed in claim 1, wherein the coordinates of the neuroanatomical coordinate system are displayed in a representation of the transformed image data.

8. The method as claimed in claim 1, wherein a plurality of transformed image data of different brains are simultaneously part of a representation.

9. The method as claimed in claim 1, wherein all method steps after a selection of initial radiological image data and actuation of a start device are performed automatically.

10. An image data processing device which projects initial radiological image data of at least a part of a brain into a neuroanatomical coordinate system, the device comprising:
an identification device to determine, in an automated fashion, anatomical reference marks in the initial radiological image data;
a normalization device to carry out at least one of a rotation and displacement of the initial radiological image data, at least some of the anatomical reference marks in the at least one of rotated and displaced image data matching corresponding anatomical reference marks in the neuroanatomical coordinate system; and
a transformation device to determine transformed image data in the neuroanatomical coordinate system from the at least one of rotated and displaced image data.

11. A radiological system comprising an image data processing device as claimed in claim 10 and a user interface for representing the transformed image data on an image output device.

12. An analysis station of a radiological system comprising an image data processing device as claimed in claim 10.

13. A modality of a radiological system comprising a control device including an image data processing device as claimed in claim 10.

14. A computer program product, loadable directly into a memory of a programmable image data processing device of a radiological system, comprising program code segments for carrying out all steps of a method as claimed in claim 1 when run in the radiological system.

15. A computer readable medium including program segments for, when executed on a computer device of a radiological system, causing the radiological system to implement the method of claim 1.

16. An image data processing device which projects initial radiological image data of at least a part of a brain into a neuroanatomical coordinate system, the device comprising:
means for automated determination of anatomical reference marks in the initial radiological image data;
means for carrying out at least one of a rotation and displacement of the initial radiological image data, at least some of the anatomical reference marks in the at least one of rotated and displaced image data matching corresponding anatomical reference marks in the neuroanatomical coordinate system; and
means for determining transformed image data in the neuroanatomical coordinate system from the at least one of rotated and displaced image data.

17. A radiological system comprising an image data processing device as claimed in claim 16 and a user interface for representing the transformed image data on an image output device.

18. An analysis station of a radiological system comprising an image data processing device as claimed in claim 16.

19. A modality of a radiological system comprising a control device including an image data processing device as claimed in claim 16.
